(19) United States
(12) Patent Application Publication
(10) Pub. No.: US 2020/0327237 A1
(43) Pub. Date: Oct. 15, 2020

(54) SYSTEMS AND METHODS FOR AGGREGATING, RANKING, AND MINIMIZING THREATS TO COMPUTER SYSTEMS BASED ON EXTERNAL VULNERABILITY INTELLIGENCE

(71) Applicant: CYBER RECONNAISSANCE, INC., Tempe, AZ (US)

(72) Inventors: Paulo Shakarian, Tempe, AZ (US); Jana Shakarian, Tempe, AZ (US); Harshdeep Singh Sandhu, Tempe, AZ (US); Mohammed Almukaynizi, Tempe, AZ (US)

(21) Appl. No.: 16/846,001

(22) Filed: Apr. 10, 2020

Related U.S. Application Data
(60) Provisional application No. 62/832,219, filed on Apr. 10, 2019.

(51) Int. Cl. G06F 21/57; G06F 21/55; G06F 17/18; G06N 20/00

(52) U.S. Cl. CPC G06F 21/577; G06N 20/00; G06F 17/18; G06F 21/554

(57) ABSTRACT

Embodiments of computer-implemented systems and methods for vulnerability-based risk transfer for aggregating, ranking, and minimizing threats to computing devices based on external vulnerability intelligence are disclosed.

### CROSS REFERENCE TO RELATED APPLICATIONS

This application claims the benefit of U.S. Provisional Patent Application No. 62/832,219, filed on Apr. 10, 2019 in its entirety, the contents of which is hereby incorporated fully herein by reference.

### FIELD

The present disclosure generally relates to predictive cyber technologies; and in particular, to cyber technologies in the form of systems, methods, and devices for aggregating, ranking, and minimizing threats to computing devices based on external vulnerability intelligence.

### BACKGROUND

An increasing number of software (and hardware) vulnerabilities are discovered and publicly disclosed every year. In 2016 alone, more than 10,000 vulnerability identifiers were assigned and at least 6,000 were publicly disclosed by the National Institute of Standards and Technology (NIST). Once the vulnerabilities are disclosed publicly, the likelihood of those vulnerabilities being exploited increases. With limited resources, organizations often look to prioritize which vulnerabilities to patch by assessing the impact it will have on the organization if exploited. Standard risk assessment systems such as Common Vulnerability Scoring System (CVSS), Microsoft Exploitability Index, Adobe Priority Rating report many vulnerabilities as severe and will be exploited to err on the side of caution. This does not alleviate the problem much since the majority of the flagged vulnerabilities will not be attacked.

NIST provides the National Vulnerability Database (NVD) which comprises of a comprehensive list of vulnerabilities disclosed, but only a small fraction of those vulnerabilities (less than 3%) are found to be exploited in the wild. Further, it has been found that the CVSS score provided by NIST is not an effective predictor of vulnerabilities being exploited.

It is with these observations in mind, among others, that various aspects of the present disclosure were conceived and developed.

### BRIEF DESCRIPTION OF THE DRAWINGS

FIG. 1 is a simplified block diagram showing a computer-implemented system for aggregating, ranking, and minimizing threats to computing devices based on external vulnerability intelligence.

FIG. 2 is a simplified block diagram showing a first embodiment of the system of FIG. 1 configured to identify at a vulnerability from at least one software component of a software stack.

FIG. 3A is a simplified block diagram showing a second embodiment of the system of FIG. 1 configured to compute an overall threat to a piece of software.

FIG. 3B is a graph illustrating probability of software exploitation according to equation 1a v. a number of software exploits.

FIG. 3C is a graph illustrating maximum probability of software exploitation according to equation 1b vs. a number of software exploits.

FIG. 3D is a graph illustrating an expected number of software exploits according to equation 1c vs. an actual number of exploits.

FIG. 3E is a graph illustrating a number of software vulnerabilities according to equation 1d v. a total number of software exploits.

FIG. 4 is a simplified block diagram showing a third embodiment of the system of FIG. 1 configured to compute an overall threat to a plurality or set of software components.

FIG. 5 is a simplified block diagram showing a fourth embodiment of the system of FIG. 1 configured to identify an impact of employing a software patch with respect to a given piece of software based on the potential of a hacker threat.

FIG. 6 is a simplified block diagram showing a fifth embodiment of the system of FIG. 1 configured to identify an impact of employing a software patch with respect to a given vulnerability based on the potential of a hacker threat.

FIG. 7 is a simplified block diagram showing a sixth embodiment of the system of FIG. 1 configured to identify an impact of employing a set of software patches corresponding to a software stack

FIG. 8 is a simplified block diagram showing a seventh embodiment of the system of FIG. 1 configured to select an optimal set of software changes for a given software stack to reduce threat (to e.g., near-maximum extent).

FIG. 9 is a simplified block diagram showing an eighth embodiment of the system of FIG. 1 configured to modify a configuration of a software stack to minimize threat while limiting the number of changes.

FIG. 10 is a simplified block diagram showing a ninth embodiment of the system of FIG. 1 configured for threat-based triage.

FIG. 11 is a simplified block diagram of a general computer-implemented method of applying aspects of the system of FIG. 1 for aggregating, ranking, and minimizing threats to computing devices based on external vulnerability intelligence.

FIG. 12 is a simplified schematic diagram of an exemplary computing device that may implement various system embodiments and methodologies described herein.

Corresponding reference characters indicate corresponding elements among the view of the drawings. The headings used in the figures do not limit the scope of the claims.

### DETAILED DESCRIPTION

Aspects of the present disclosure relate to a computer-implemented system (“system”) and associated methods for aggregating, ranking, and minimizing threats to computing devices based on external vulnerability intelligence. In general, embodiments of the system may be configured for identifying vulnerabilities for a given technology configuration implemented by some entity such as a software stack, computing an overall threat to a particular technology such as a software component including any program, application, or piece of software, computing a threat to a software stack, computing an overall threat to an endpoint of a network such as a computing device. In some embodiments, the system may be configured for identifying the impact of employing a software patch associated with some piece of software or given vulnerability based on a possible hacker threat, identifying an impact of employing a set of software patches associated with some software stack based on a possible hacker threat, selecting an optimal set of software changes for a given software stack to reduce threat to near-maximum/minimum extent, changing the configuration of a software stack to reduce or minimize threat while limiting the number of changes, and applying threat-based alert triage.

Introduction and Technical Challenges

Common Vulnerabilities and Exposures (CVE) is a unique identifier assigned to each software vulnerability reported in the National Vulnerability Database (NVD), a reference vulnerability database maintained by the National Institute of Standards and Technology (see nvd.nist.gov). The CVE numbering system follows one of these two formats:
CVE-YYYY-NNNN; and
CVE-YYYY-NNNNNNN.

The “YYYY” portion of the identifier indicates the year in which the software flaw is reported, and the N's portion is an integer that identifies a flaw (e.g., see CVE-2018-4917 related to https://nvd.nist.gov/vuln/detail/CVE-2018-4917, and CVE-2019-9896 related to https://nvd.nist.gov/vuln/detail/CVE-2019-9896).

A Common Platform Enumeration (CPE) is a list of software/hardware products that are vulnerable to a given CVE. The CVE and the respected platforms that are affected, i.e., CPE data, can be obtained from the NVD. For example, the following CPEs are some of the CPEs vulnerable to CVE-2018-4917:
cpe:2.3:a:adobe:acrobat_2017:*:*:*:*:*:*:*:*
cpe:2.3:a:adobe:acrobat_reader_dc:15.006.30033:*:*:*:classic:*:*:*
cpe:2.3:a:adobe:acrobat_reader_dc:15.006,30060:*:*:*:classic:*:*:*

The Common Vulnerability Scoring System (CVSS) is a numerical score capturing the severity level of software vulnerabilities based on the technical characteristics such as the ease of exploitation and an approximation of impact it would leave if it is exploited. CVSS ranges from 0 to 10 (the most severe score).

A Software stack (inventory) is a collection of software products installed on a computer host (to include public-facing server, cloud instances, endpoint machines, etc.). In some cases, a software stack's information may be recorded or otherwise accessible. The Information about a given software stack can be obtained by different ways. For example, a list maintained by the system administrators indicting what software is on each host, a computer database storing such information, a piece of software that can identify the software stack on a given host such as “wmic product get name,version” on Microsoft Windows, Amazon Web Services (AWS) System Manager, etc. Information about a software stack may also be provided in some computer registry. Each item in a software stack may or may not have some metadata indicated, e.g., when each software item was installed, a version number, the instances to which it is installed, the port number, etc.

Below are two examples of software stacks:
1. A software stack identified by AWS System Manager:

TABLE 1
Software stack identified from AWS inventory

| Product | Version |
|---|---|
| bzip2 | 1.0.6-8 |
| curl | 7.47.0 |
| binutils | 2.26.1 |
| bash | 4.3 |

2. A software stack identified by the wmic tool on Microsoft Windows 10 computer system

TABLE 2
Software stack identified from wmic on Windows

| Product | Version |
|---|---|
| Adobe Acrobat Reader DC | 19.010.2009 |
| PuTTY release 0.70 | 0.70.0. |
| Microsoft Visual C++ 2005 Redistributable | 8.0.6100 |
| Java 8 Update 191 (64-bit) | 8.0.1910.1 |

Notation: When software stacks and related aspects are described herein, for a given piece of software version swⱼ, or for short ⱼ, we will use the numbers 1, . . . ,j, . . . nⱼ to designate all versions where j will be normally used as an index. For a range of versions we will use the notation j, . . . , mⱼ. When two pieces of software are discussed together, we will use q,r and i,j (for versions r of q and version j of i respectively). In addition, while the examples below relate to possible software stacks being implemented by an entity in some form, a CPE may also include hardware specifications susceptible to some vulnerability, and may further include hardware and software combinations.

Technical Challenges: Information technology (IT) administrators lack sufficient technical means for efficiently identifying and practically addressing possible vulnerabilities of a technology configuration such as determining how to approach a given vulnerability (versus another). A given IT environment may be potentially susceptible to thousands of security vulnerabilities (at least those identifiable via the NVD). While the NVD and CVSS provides baseline information about some threats, there is insufficient technology presently available that might allow IT administrators to actually make sense of and intelligently leverage such information to apply responsive measures and prioritize patches or other fixes, and predict actual attacks based on the specifics of a given technology configuration.

General Specifications of System Responsive to Technical Challenges

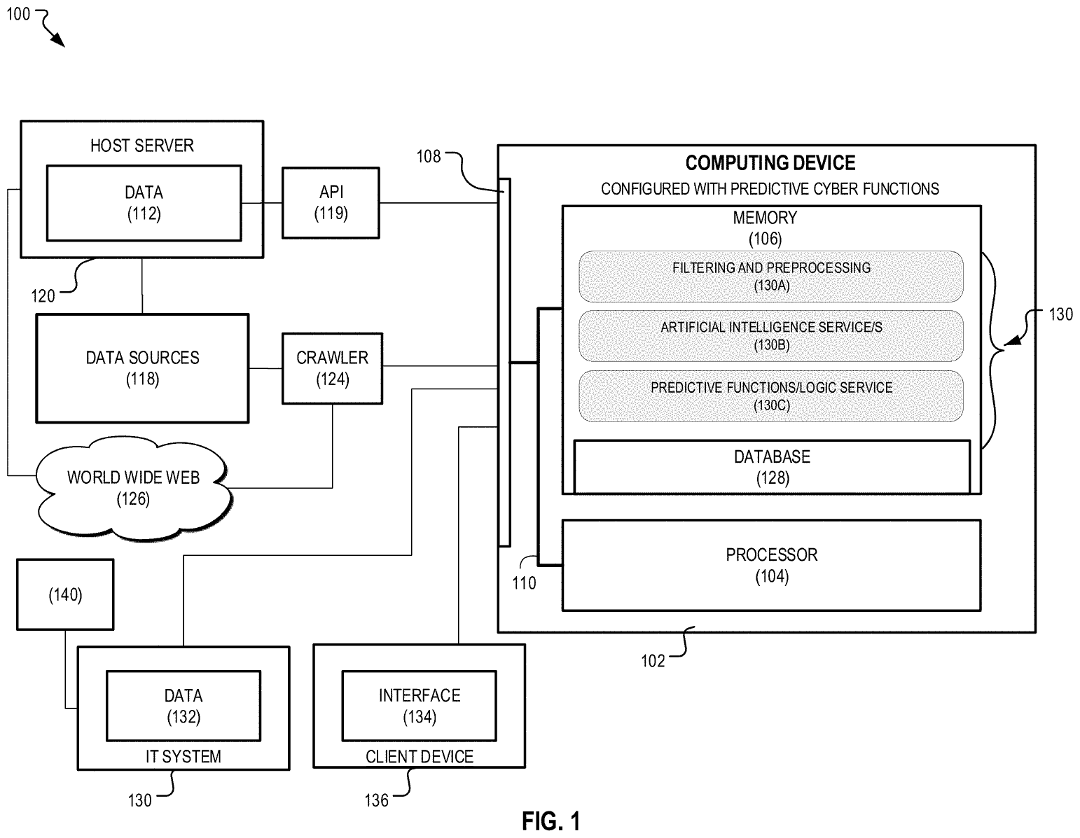

Referring to FIG. 1, an inventive concept responsive to the aforementioned technical challenges may take the form of a computer-implemented system, designated system 100, comprising any number of computing devices or processing elements. In general, the system 100 leverages artificial intelligence to implement cyber predictive methods such as aggregating, ranking, and minimizing threats to computing devices based on external vulnerability intelligence. While the present inventive concept is described primarily as an implementation of the system, it should be appreciated that the inventive concept may also take the form of tangible, non-transitory, computer-readable media having instructions encoded thereon and executable by a processor, and any number of methods related to embodiments of the system described herein.

In some embodiments, the system 100 comprises a computing device 102 including a processor 104, a memory 106 of the computing device 102 (or separately implemented), a network interface (or multiple network interfaces) 108, and a bus 110 (or wireless medium) for interconnecting the aforementioned components. The network interface 108 includes the mechanical, electrical, and signaling circuitry for communicating data over links (e.g., wires or wireless links) within a network (e.g., the Internet). The network interface 108 may be configured to transmit and/or receive data using a variety of different communication protocols, as will be understood by those skilled in the art.

As indicated, via the network interface 108 or otherwise, the computing device 102 is adapted to access data 112 from a host server 120 or other remote computing device and the data 112 may be generally stored/aggregated within a storage device (not shown) or locally stored within the memory 106. The data 112 includes any information about cybersecurity events across multiple technology platforms referenced herein, information about known vulnerabilities associated with hardware and software components, any information from the NVD including updates, and may further include, without limitation, information gathered regarding possible hardware and software components/parameters being implemented by a given technology configuration associated with some entity such as a company. A technology configuration may include software and may define software stacks and individual software applications/pieces, may include hardware, and combinations thereof, and may generally relate to an overall network or IT infrastructure environment including telecommunications devices and other components, computing devices, and the like.

As shown, the computing device 102 is adapted, via the network interface 108 or otherwise, to access the data 112 from various data sources 118 (such as the deep or dark web (D2web), or the general Internet). In some embodiments, the computing device 102 accesses the data 112 by engaging an application programming interface 119 to establish a temporary communication link with a host server 120 associated with the data sources 118. Alternatively, or in combination, the computing device 102 may be configured to implement a crawler 124 (or spider or the like) to extract the data 112 from the data sources 118 without aid of a separate device (e.g., host server 120). Further, the computing device 102 may access the data 112 from any number or type of devices providing data via the general Internet or World Wide Web 126 as needed, with or without aid from the host server 120.

The data 112 may generally define or be organized into datasets which may be aggregated or accessed by the computing device 102 and may be stored within a database 128. Once this data is accessed and/or stored in the database 128, the processor 104 is operable to execute a plurality of services 130, encoded as instructions within the memory 106 and executable by the processor 104, to process the data so as to determine correlations and generate rules or predictive functions, as further described herein. The services 130 of the system 100 may generally include, without limitation, a filtering and preprocessing service 130A for, in general preparing the data 112 for machine learning or further use; an artificial service 130B comprising any number or type of artificial intelligence functions for modeling the data 112 (e.g., natural language processing, classification, neural networks, linear regression, etc.); and a predictive functions/logic service 130C that outputs one or more values suitable for reducing risk, such as a probability of exploit of the vulnerability, an overall threat value, and the like, as further described herein. The plurality of services 130 may include any number of components or modules executed by the processor 104 or otherwise implemented. Accordingly, in some embodiments, one or more of the plurality of services 130 may be implemented as code and/or machine-executable instructions executable by the processor 104 that may represent one or more of a procedure, a function, a subprogram, a program, a routine, a subroutine, a module, an object, a software package, a class, or any combination of instructions, data structures, or program statements, and the like. In other words, one or more of the plurality of services 130 described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 106), and the processor 104 performs the tasks defined by the code.

As shown, the computing device 102 may be in operable communication with some device associated with at least one of an information technology (IT) system 130 or enterprise network. The IT system 130 may include any system architecture, IT system, network, or configuration where it is desired to assess possible vulnerabilities to the IT system 130, rank these vulnerabilities, and apply the functionality described herein to reduce risk to the IT system 130. The IT system 130 may further include data 132 defining some configuration of possible hardware and/or software components (e.g., various software stacks) that may be susceptible to vulnerabilities.

As further shown, the system 100 may include an interface 134 including a portal or gateway embodied as an API, browser-based application, mobile application, or the like. The interface 134 may be executable or accessible by a remote computing device (e.g., client device 136) and may provide predefined access to aspects of the system 100 for any number of users. For example, accessing the portal 134, a user may provide information about an external IT system (such as data 132) so that the computing device 102 can process this information according to the plurality of services 130 and return some output value useful for reducing vulnerability and exploit risk to the external IT system.

### Exemplary Embodiments of the System (100)

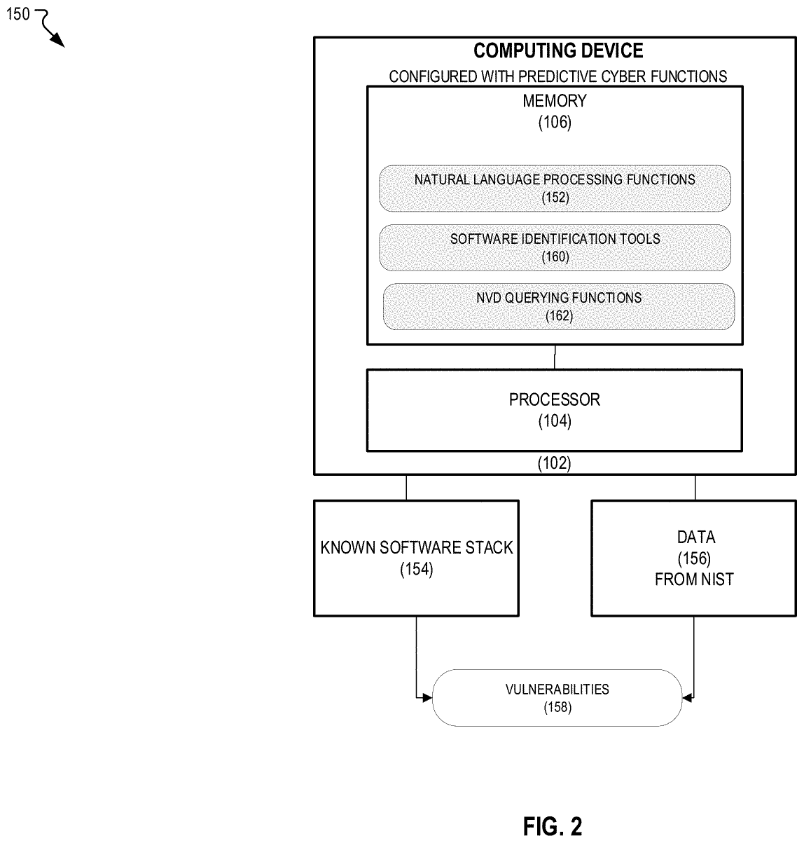

Referring to FIG. 2, in a first embodiment 150 of the system 100, the system 100 is configured to identify vulnerabilities for a given software stack. In this embodiment 150 of the system 100, the system 100 executes any number of natural language processing functions 152 (e.g., keyword or character matching) stored within the memory 106 and executable by the processor 104 to align the inventory of a known software stack 154 with data 156 from the NIST's CPE numbering system, which then, in-turn, aligns components of the inventory of the software stack 154 with possible vulnerabilities 158 (numbered by CVE number). Many natural language processing techniques can be implemented by the natural language processing functions 152, including methods that leverage document similarity approaches applied on bag-of-word text representation such as TF-IDF; topic modeling approaches such as LISA; and deep learning and embedding techniques such as word2vec; or via a combination of more than one technique. The computing device 102 may further leverage any number or type of software identification tools 160 to identify the particulars of the software stack 154.

For example, a keyword match approach defined by the natural language processing functions 152 may be leveraged to identify the CPEs relating to each of the products identified in Table 1, and from which, the CVEs can be identified by querying (using e.g., NVD querying functions 162 stored as instructions within the memory 106 and executable by the processor 104) the NVD for each CPE as below:

TABLE 3
CVEs identified from the AWS software stack

| Product | Version | CPE | CVE's |
|---|---|---|---|
| bzip2 | 1.0.6-6 | cpe:2.3:a:bzip2:1.0.6:*:*:*:*:*:*:* | CVE-2016-3189 |
| curl | 7.47.0 | cpe:2.3:a:haxx:libcurl:7.47.0:*:*:*:*:*:*:* | CVE-2019-3823, CVE-2019-3822 |
| binutils | 2.26.1 | cpe:2.3:a:gnu:binutils:2.26.1:*:*:*:*:*:*:* | CVE-2018-20671, CVE-2018-1000876 |
| bash | 4.3 | cpe:2.3:a:gnu:bash:4.3:*:*:*:*:*:*:* | CVE-2019-9924, CVE-2016-0634, CVE-2016-7543 |

Similarly, we can obtain the CVEs relating to the software stack identified in Table 2:

TABLE 4
CVEs identified from the wmic software stack

| Product | Version | CPE | CVE's |
|---|---|---|---|
| Adobe Acrobat | 19.010.20091 | cpe:2.3:a:adobe:acrobat_dc:19.010.20098:*:*:*:classic:* | CVE-2018-4918 |
| Render DC | | | |
| PuTTY release 0.70 | 0.70 | cpe:2.3:a:putty:putty:0.70:*:*:*:*:*:* | CVE-2019-9896 |
| Microsoft Visual | 8.0.6100 | cpe:2.3:a:microsoft:visual_c\+\+:8.0:*:*:*:*:*:* | CVE-2019-2426 |
| C++ 2005 | | | |
| Redistributable | | | |
| Java 8 Update 191 | 8.0.1910.1 | cpe:2.3:a:oracle:jre:8.0:*:*:*:*:*:* | CVE-2019-2426 |
| (64-bit) | | | |

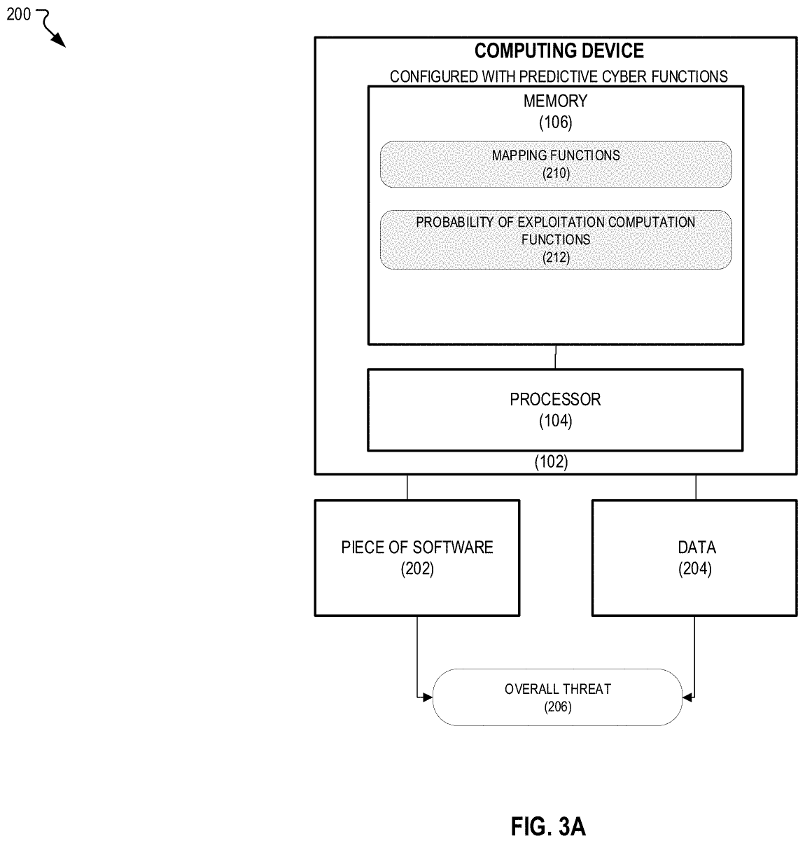

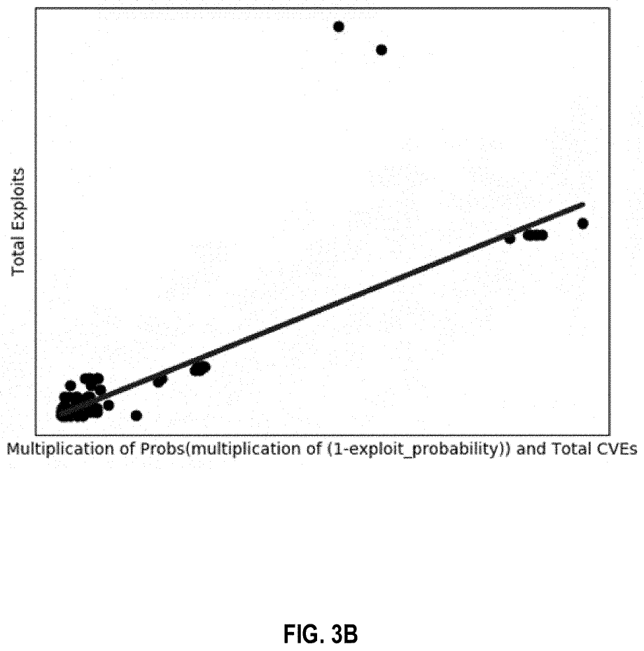

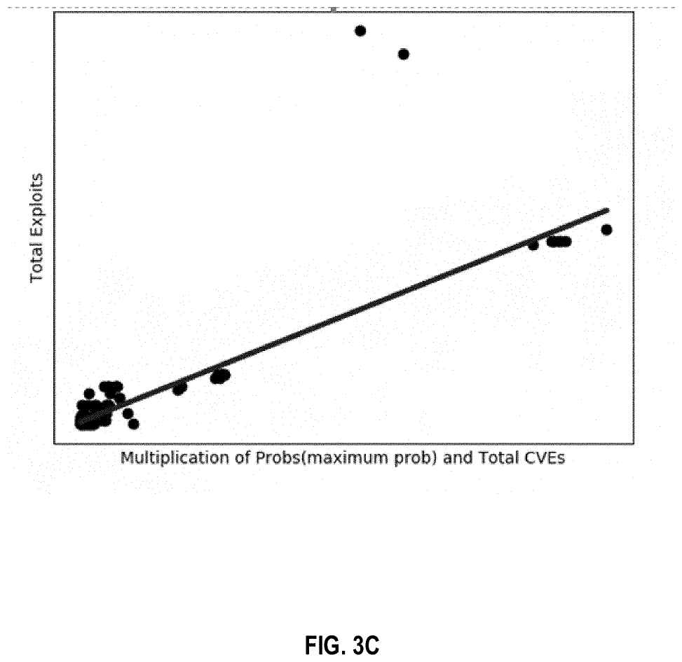

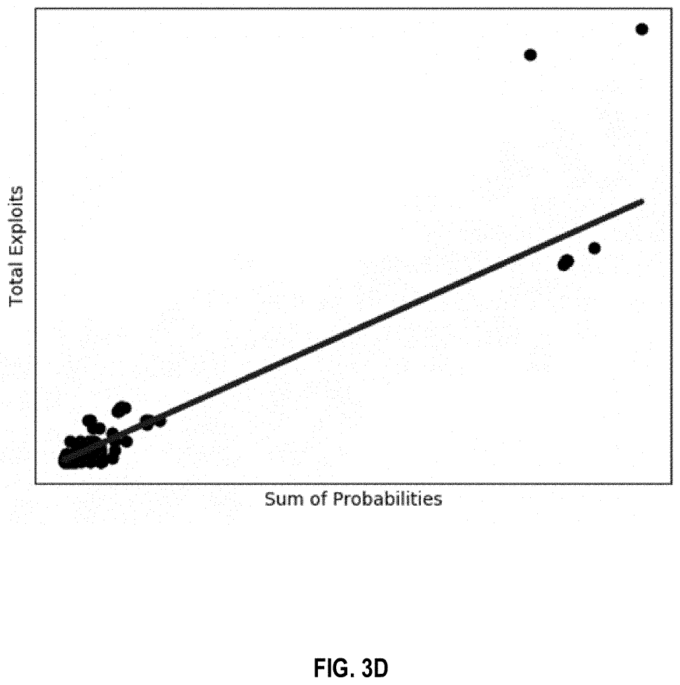

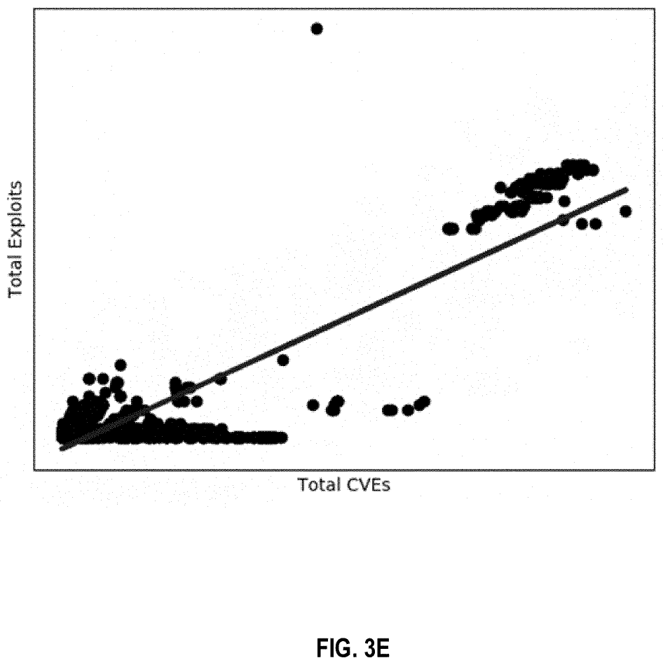

Referring to FIG. 3A, in a second embodiment 200, the system 100 is configured to compute an overall threat to a single, or sole piece of software based on a probability of exploitation. In this embodiment 200, given a piece of software 202 identified by or otherwise corresponding to a CPE (numbered x), the piece of software 202 is then mapped to data 204 defining one or more vulnerabilities or CVEs (numbered 1, . . . ,nₓ) associated with the piece of software 202. Each CVE (we will say it is numbered with number y) may be associated with a probability of exploitation, p_{y}.

If the probability of exploitation is not available, then p_{y} will be equal to the probability of a given CVE being exploited at random. So, we compute the probability of the software being exploited (Cx) as:

$${c}_{x} = 1 - {\prod }_{y ∈ \{ 1 , … , {n}_{x} \}} ( 1 - {p}_{y} ) . \qquad ( 1 a . )$$

where the probability of system exploitation Cx is equal to 1 minus the probability that none of the vulnerabilities are going to be exploited.

Probability can also be computed differently, for example, consider the following:

$${c}_{x} = {max}_{y ∈ \{ 1 , … , {n}_{x} \}} {p}_{y} , \qquad ( 1 b . )$$

where the probability of system exploitation Cx is expressed by taking the probability of exploitation of the vulnerability that has the highest probability of exploitation.

Additionally, threat can be interpreted differently, for example as the expected number of attacks against a piece of software, which can be computed as an expected value as follows:

$${c}_{x} = {\sum }_{y ∈ \{ 1 , … , {n}_{x} \}} {p}_{y} , \qquad ( 1 c . )$$

where the probability of system exploitation Cx is expressed as the expected number of vulnerabilities that are going to be exploited.

Or it can be computed based on the number of vulnerabilities:

cₓ=nₓ, (1d)
where the number of vulnerabilities might be a good approximation of the threat level.

An overall threat probability 206 value or threat of probability of exploitation can be computed using different approaches including but not limited to:
Deriving from the CVSS score (any version),
Deriving the probability from the number of online hacking discussions, and
Deriving the probability from external systems that compute the likelihood of exploitation.

One or more mapping functions 210 may be stored as computer-readable instructions within the memory 106 and executable by the processor 104. In addition, equations 1a-1c above may be defined within probability of exploitation functions 212 and may also be stored as computer-readable instructions within the memory 106 and executable by the processor 104. Any of the aforementioned functions may be defined within the plurality of services 130 or separately defined.

FIGS. 3B-3E illustrate that some of these measures correspond with the number of exploits actually found for a given piece of software; such that the measures have been shown to be predictive. In other words, it is visually evident from FIGS. 3B-3E that these measures correspond well with the actual total number of software exploits. We would like to show, numerically, that this correlation is significant. To do so, a linear regression model is fit to the software data points, and we use coefficient of determination (R²) and mean squared error (MSE) to demonstrate the significance of the said correlation as below:

TABLE 5
Significance of Correlation

| Measure | R² | Mean Squared Error |
|---|---|---|
| (1a.) | 0.73 | 50.51 |
| (1b.) | 0.73 | 49.77 |
| (1c.) | 0.86 | 26.49 |
| (1d.) | 0.82 | 32.00 |

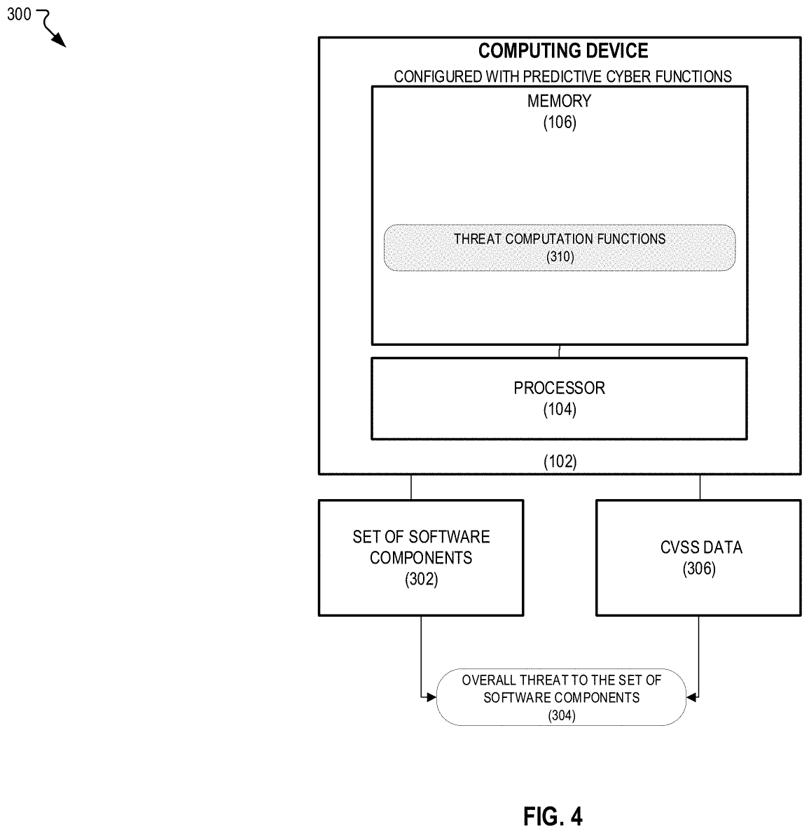

Referring to FIG. 4, in a third embodiment 300, the system 100 is configured to compute an overall threat to a set of software components 302 (versus a sole component in embodiment 200), such as a software stack defining a set of CPEs, and/or an overall threat to a computer system (e.g., an endpoint).

For example, given multiple pieces of software denoted swₓ (x numbered from 1 to n), then an overall threat 304 to the software may computed by the processor 104 as follows:

1−Π_{x∈{1, . . . ,n}}(1−cₓ), (2.)
where the overall threat is expressed as 1 minus the probability that none of the set of software components 302 are going to be exploited.

Alternatively, this can also be computed directly for a computer system (i.e. endpoint or server, such as endpoint 140 of FIG. 1) based directly on the vulnerabilities present on that system. Given the output of a vulnerability scanning software (i.e. Tenable, Qualys, Rapid7, etc.) for a given computer (normally identified by IP address) there is a list of vulnerabilities. For a given computer system with vulnerabilities 1, . . . ,n (identified by CVE or similar numbering system) with associated probabilities (pₓ for vulnerability x), the probability of the system being compromised by a given vulnerability (under independence assumptions) can be expressed as follows:

$$1 - {\prod }_{x ∈ \{ 1 , … , n \}} ( 1 - {p}_{x} ) . \qquad ( 3 a . )$$

The probability of the system being compromised can be computed using other conventional approaches such as the NISI CVSS score (leveraging CVSS data 306):

$$1 - {\prod }_{x ∈ \{ 1 , … , n \}} ( 1 - \frac{{CVSS}_{x}}{10} ) . \qquad ( 3 b . )$$

The CVSS score ranges from 0 to 10 (most severe), hence the division on 10 in (3b). Additionally, it can be computed using the prior probability of vulnerability exploitation, i.e.,

### Pprior.)

1−(1−pₚᵣᵢₒᵣ)ⁿ. (3c.)

Accordingly, the embodiment 300 computes an overall threat to a set or collection of pieces of software or software components. This embodiment 300 may or may not utilize the output of the second embodiment 200. For example, equation 2 utilizes the output of embodiment 200, but equation 3c does not. Threat computation functions 310 may be stored as computer-readable instructions within the memory 106 and executable by the processor 104 and may encompass equation 2 and equations 3a-3c.

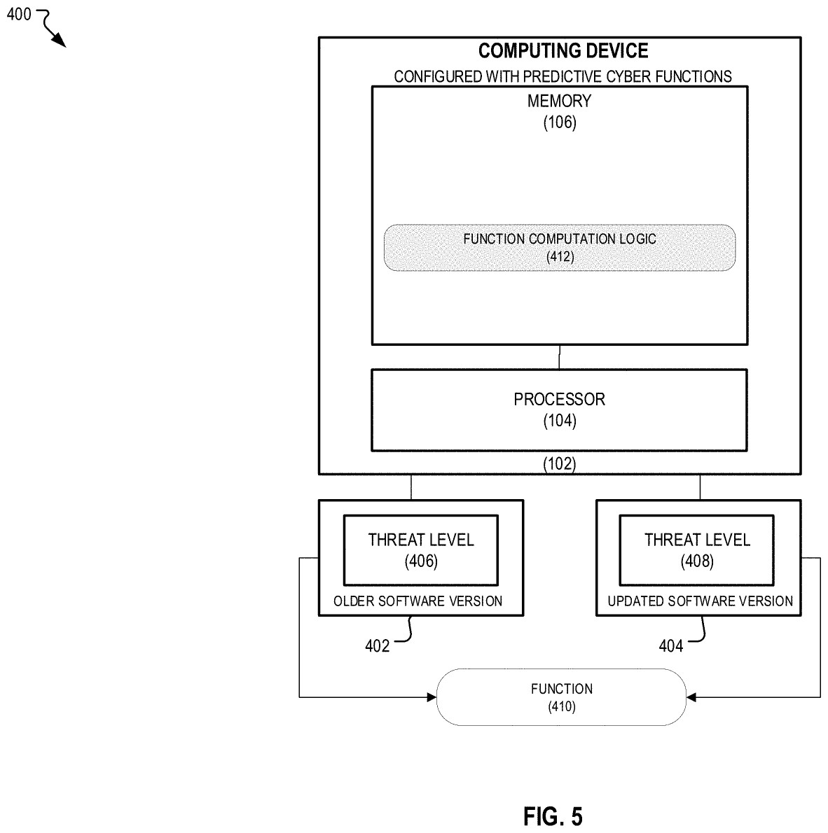

Referring to FIG. 5, in a fourth embodiment 400, the system 100 is configured to identify an impact of employing a software patch with respect to a given piece of software based on the potential of a hacker threat. Accordingly, we now switch focus to identifying the optimal defensive action(s), i.e., least amount of work needed to provide the most reduction in threat level. This embodiment 400 focuses on identifying a function 410 that quantifies the impact of upgrading a piece of software (older software version 402) to a newer version (updated software version 404), each of which may have a SET of vulnerabilities. The input to the function 410 includes two arguments: (1) the threat level 406 on the older software version 402, and (2) the threat level on the newer version. Each threat level may be computed in a way similar to the functionality set out in the description of the second embodiment 200, or by any of the methods listed below.

Any given piece of software, identified uniquely (i.e. by the NISI CPE numbering system) can be “upgraded” to a comparable piece of software also uniquely identified (i.e., by installing a software update). This imposes a partial ordering over a universe of pieces of software. Function computation logic 412 encoded as instructions within the memory 106 and executable by the processor 104 can be executed and may encompass the following functionality for deriving the function 410:

The term sw may denote a piece of software and subscripts denote versions. The ordering symbol denotes the upgrade relationship. Here, software j is an upgrade to software i:
swᵢ⊏swⱼ

For example, sw, and stv, could be cpe:2.3:a:putty:putty:0,70:*:*:*:*:*:* and cpe:2.3:a:putty:putty:0,71:*:*:*:*:*:*, respectfully.

For a given piece of software, we assume a function m that specifies various facets of the software, such as:
number of vulnerabilities for that software, i.e., nₓ.
number of exploits for that software, which can be queried from some databases, e.g., Symantec's Anti-virus attack signatures
number of exploit proof of concept's (PoC's) for that software, which can be queried from some PoC archives such as ExploitDB
number of Metasploit exploit Modules for that software, which can be queried from TippingPoint's website
number of threat actors discussing the software, which can be queried from some cyber-threat intelligence databases
variants of the above methods over time
expected number of the above items determined using statistical, machine learning, artificial intelligence, algorithmic, or other mathematical approach
other quantified metrics of risk or threat applied to the given piece of software

Any of the above-listed metrics can be expressed with the function m that maps a piece of software to a real-valued number. Hence, we can define impact as follows:
for software swᵢ⊏swⱼ, and metric m, we define the impact of upgrading from i to j as f(m(swⱼ),m(swᵢ)) where f is some function (i.e. subtraction, division, or other comparable function that maps two reals to a real-valued number) that is implemented in a piece of software.

For the same examples of PuTTY's version 0.70 (swᵢ) and version 0.71 (sw;), let 171 be m be the number of vulnerabilities for each version, and f be the difference between its two arguments. This gives:
m(swᵢ)=4
m(swⱼ)=3
f(m(swⱼ),m(swᵢ))=1.

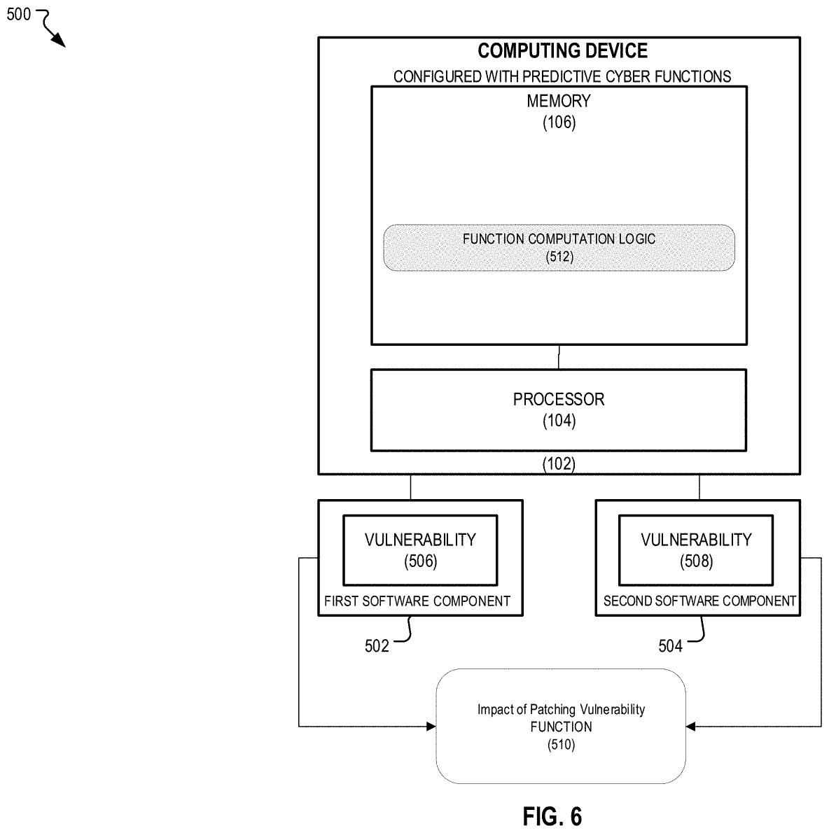

Referring to FIG. 6, in a fifth embodiment 500, the system 100 is configured to identify an impact of employing a software patch with respect to a given vulnerability based on the potential of a hacker threat. Given a piece of software, identified in the same manner as described in earlier, we identify and define a function vuln as a function that accepts such a piece of software and returns a list of vulnerabilities. The CPE and CVE numbering system provided by NIST is an example of a numbering system that can be described in this manner.

In other words, a function 510 is derived that quantifies the impact (reduction in threat level) of patching a single vulnerability. By contrast, the embodiment 400 may be more generic, i.e., measures the overall impact of upgrading from one version of software to another, which may result in patching a number of vulnerabilities, or may not be a security-related upgrade, e.g., an upgrade to add new functionality. Function computation logic 512 encoded as instructions within the memory 106 and executable by the processor 104 can be executed and may encompass the following functionality for deriving the function 510:

For a given vulnerability v, we define two pieces of software (illustrated in FIG. 6 as first software component 502 and second software component 504), sw_{v,i} and sw_{v,i} as follows:
sw_{v,i}:
   v∈vuln(sw_{v,l})
   sw_{v,i′} such that:
      v∈vuln(sw_{v,i′}) and
      sw_{v,i}⊏sw_{v,i},

In words: vulnerability v can be found in sw_{v,i} and there is no upgrade to that software which contains vulnerability v.
sw_{v,j}:
   v∉vuln(sw_{v,j}):
   sw_{v,j′} such that:
      v∉vuln(sw_{v,j′}) and
      sw_{v,j′}⊏sw_{v,j}

In words: the vulnerability v cannot be found in sw_{v,j} and that software is an upgrade to a piece of software that must have the vulnerability v (FIG. 6 illustrates vulnerability 506 for first software component and vulnerability 508 for second software component 504).

Now, using the same notation as defined for the embodiment 400, we say the impact of patching a vulnerability v is defined as f (m(sw_{j,v}),m(sw_{i,v})) where f and m are defined with the various options described in embodiment 400 and the computation is implemented in a piece of software.

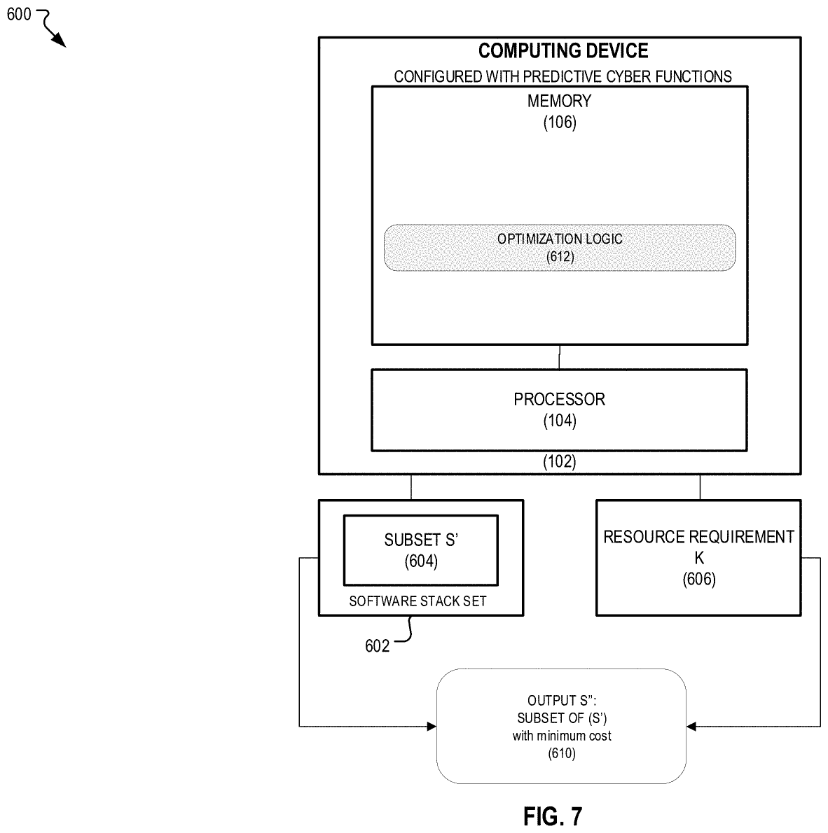

Referring to FIG. 7, in a sixth embodiment 600, the system 100 is configured to identify an impact of employing a set of software patches corresponding to a software stack. A given software stack 602, running on a computer system or on a computer network, defines an inventory of various software components 604 or pieces running on said stack and an inventory of vulnerabilities 606 for the software stack may be computed as described herein. Specifically, the software and vulnerabilities can be identified by standard numbering systems (i.e. NIST's CPE and CVE numbers) using the same conventions as described for the embodiments 150, 200, 300, 400, and 500 of the system 100.

In general the embodiment 600 of the system 100 is configured to solve an optimization problem. With the software stack 602, we know there may exist many newer versions that may be possibly applied to each piece of software in the software stack 602, but we have limited resources, i.e., we can apply a limited number of upgrades (this number may be denoted as k). Now, embodiment 600 helps to determine optimal combinations of software upgrades that may be applied (noting we cannot exceed k upgrades) that are the best in reducing the overall threat level (and we know from other embodiments of the system 100 how to compute the threat level). Logic for solving the optimization problem may be implemented as optimization logic 612 encoded as instructions within the memory 106 and executable by the processor 104 can be executed and may encompass the following functionality for deriving the function 510:

We assume the existence of a function vulnCost that maps sets of vulnerabilities to real-valued numbers. The intuition is that for a given set of vulnerabilities V, the value returned by vulnCost(V) is a proxy for the risk or threat to the computer system containing the vulnerabilities in set V (similar to the embodiments 200 and 300). In addition to the methods related to the embodiment 300 of the system 100, there are several methods possible for computing vulnCost relating to the risk associated with malicious hacker threating those vulnerabilities:
The total number of current exploits available for the vulnerabilities in set V
The expected number of exploits for the vulnerabilities in set V computed using statistical, machine learning, artificial intelligence, algorithmic, or other computational methods
The number of hackers (malicious or non-malicious) discussing vulnerabilities in set V or some measurement derived from the hacker personalities, social structure, and discussion content of the hackers interested in vulnerabilities in set V
Probability of an incident occurring to the system based on the current or projected exploits available for vulnerabilities in set V that may or may not account for the interdependencies and attack paths among the vulnerabilities in V (again, computed statistical, machine learning, artificial intelligence, algorithmic, or other computational methods)
An additive cost function where for each vulnerability v in set V there is an associated real-valued cost (denoted by the symbol cv). Such a function can be expressed as Σ_{v∈v}^{cv}. The value cᵥ, (for each vulnerability v) can be computed in one of several ways:
   Number of exploits for vulnerability v
   NIST CVSS score (any version) for vulnerability v
   Probability of an exploit existing for vulnerability v, i.e., pᵥ
   Number of threat actors discussing v over a period of time
   Number of malware packages existing for vulnerability
   Number of proof-of-concept (POC) exploits available for vulnerability v
   Other methods of scoring risk or quantified threat for an individual vulnerability using statistical, machine learning, artificial intelligence, algorithmic, or other computational methods
Other methods for computing risk scores or quantifying threat to the vulnerabilities in set V.

We use the notation S to denote the set of software running on the software stack (this results from the inventory of the system described earlier for this embodiment 600). We also assume that there is a set of “software upgrades” available to the system 100, S′ that is defined as follows (using the notation from previous embodiments of the system 100):
S′⊂{s such that ∃s′∈S where s′⊏s and ∃v∈vuln(s′) such that v∉vuln(s)}

In other words, S′ is a subset of all other pieces of software (outside of S) that are upgrades (newer versions) of the software in S that where each piece of software in S′ does not contain at least one vulnerability found in a piece of software in S.

For a given set of software S. we can express the total set of vulnerabilities for S as U_{s∈s}^{vuln(s)} which in words is all vulnerabilities in the pieces of software S. We note that, in addition to patching, there may be other vulnerabilities mitigated by the system administrator using means other than patching we will call these vulnerabilities V_{mitigate}. Note these vulnerabilities are separate from V. While set V is a subset of U_{s∈s}^{vuln(s)}, it is possible for V_{mitigate} to contain other vulnerabilities. However, the set U_{s∈s}^{vuln(s)} must be the subset of the union of V and V_{mitigate}. This is because all vulnerabilities on the system are either exposed (in set V) or are mitigated by other means (in set V_{mitigate}).

Next, for a given subset of S, denoted S″ we define the set of “upgraded” software on the computer system as including S″ and any software in S that was not upgraded. Formally:
newStack(S,S″)=S″∪{s∈S s.t.∃—s′∈S″ where s⊏s′}

Hence, a key problem the embodiment 600 solves is as follows: given sets S (illustrated as 602) and S′ (illustrated as 604) and resource requirement K (a natural number) (illustrated as 606), identify subset of S′ (denoted S″ and illustrated as 610) of size K such that the cost associated with the new vulnerabilities is minimized. Formally defined in Objective Function 1 below.

$$min \text{?} vulnCost ( vuln ( newStack ( S , {S}^{″} ) ) - {V}_{mitigate} \\ \text{?} \text{indicates text missing or illegible when filed} \qquad Objective Function 1$$

This functionality of the optimization logic 612 is configured to minimize the threat to the upgraded computer system, i. e., containing the vulnerabilities in the set of upgraded software products. Some of these vulnerabilities may not pose risk because they may be mitigated using some defensive measure implemented by the system admin (close some service ports). This optimization function is subject to the constraints listed below.

As an example, this problem can be solved using integer programming techniques (especially when the cost function is a linear combination of individual vulnerability costs, as we will use in this example).

We shall use the set Vail-possible to denote all possible vulnerabilities to the system. This includes all vulnerabilities to software in sets S and S′ less the vulnerabilities in set V_{mitigate}. Formally:

$${V}_{alt - possible} = ( ⋃ \text{?} vuln ( s ) ) - {V}_{mitigate}$$

$$\text{?} \text{indicates text missing or illegible when filed}$$

When expressed as an integer program, we first define variables that correspond with each vulnerability and each piece of software.
Constraint 1: For each vulnerability v∈V_{all-possible} we define a variable Yₛ∈{0,1}.
Constraint 2: For each vulnerability s∈S∪S′ we define a variable Yₛ∈{0,1}.

With each vulnerability (v), we will assume a constant, additive cost, cᵥ. To ensure a vulnerability is counted if a given piece of software is selected, we must define the following constraint:
Constraint 3: ∀s,v such that v∈vuln(s): Xᵥ≥Tₛ

To ensure that only K pieces of software are upgraded, we limit the selection of software with the following constraint:
Constraint 4: Σ_{s∈S}, Yₛ≤K

To ensure that each current piece of software is either retained or upgraded, we add the following constraint:
Constraint 5: ∀s, Σ_{s′∈S′ such that s⊏s}, Yₛ≥1

Finally, the Objective Function 1 can be expressed as the following:
Σ_{v∈V}_{_{all-possible}} cᵥXᵥ;

and minimizing this function with respect to Constraints 1-5 corresponds precisely to the solution to the underlying problem. It can be solved by a variety of “out-of-the-box” integer program solvers such as CPLEX or QSOPT.

We note that this algorithm provides a constructive result meaning that it tells the user both which software to patch (as these are Y variables that will be set to 1 by the solver) and which vulnerabilities are patched as a result (as these are X variables that will be set to 0 by the solver), Additionally, it will also report which vulnerabilities are remaining including new vulnerabilities induced by replacing software (X variables set to 1 by the solver).

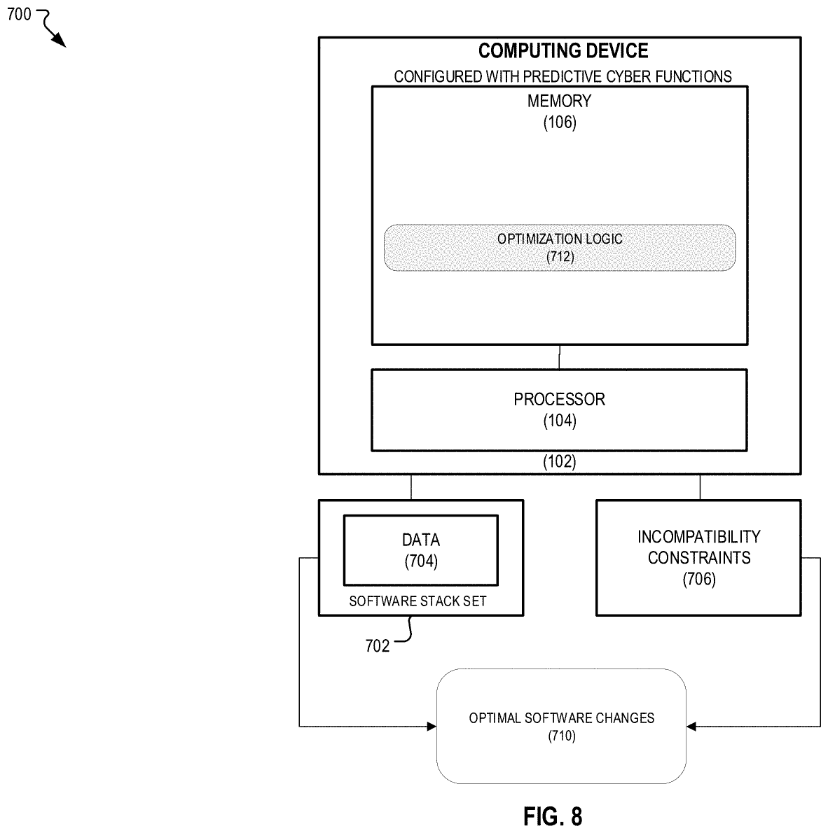

Referring to FIG. 8, in a seventh embodiment 700, the system 100 is configured to select an optimal set of software changes for a given software stack to reduce threat (to e.g., near-maximum extent). This is similar to embodiment 600 but embodiment 700 is configured to handle incompatibility among software components or products (listed or delineated as data 704) of a software stack 702 where at least one of the components or products of the software stack 702 may be upgraded, i.e., the embodiment 700 models incompatibility and adds new constraints to the optimization problem. Applying optimization logic 712 encoded as instructions within the memory 106 and executable by the processor 104, a set of integer programming constraints may be processed to compute an optimal selection of one or more software changes 710, as follows.

For each piece of software i and each version of that software j, there is a variable X_{i,j} associated with it. It can take on a value of zero or 1 and precisely one version of each piece of software is selected. These can be modeled with the following integer programming constraints (1 and 2) as follows:

∀i,j:X_{i,j}∈{0,1} (4.)

∀i:ΣⱼX_{i,j}=1 (5.)

Ideally, we want to minimize the threat. For a given software stack, this is equivalent to expression (3.). However, we notice that the log-likelihood of that function exhibits the same behavior (and we take the maximum by removing the leading constant and eliminating the subtraction symbol). This give us the following objective function for the set of constraints.

So, in a simple set of constraints, consisting of maximizing equation 6 subject to 4 and 5, the program would set all X_{i,j} to either zero or 1—so if it is 1 then the user uses version j of software I (and constraint 5 ensures that only one version will be picked for each software.

Now, suppose the user notices that two pieces of software selected are incompatible say version j of software i and version r of software q. The user can then let the system know about each incompatibility and the system add the following constraint (illustrated as incompatibility constraints 706) for each one and will then resolve the integer program:

X_{q,r}+X_{i,j}≤1 (7.)

Alternatively, the user can also specify ranges of software versions that would be required in a dependency. For example, versions sr thru tᵣ of software q require a version of software i that is between s, and tᵢ. The following constraint enables this requirement.

Σᵣ₌ₛ_{_{q}}^{t}^{_{q}}X_{q,r}≤Σⱼ₌ₛ_{ₗ}^{t}^{ᵢ}X_{i,j} (8.)

So, in the end, equation 6 is maximized subject to equations 4, 5, 7, and 8.

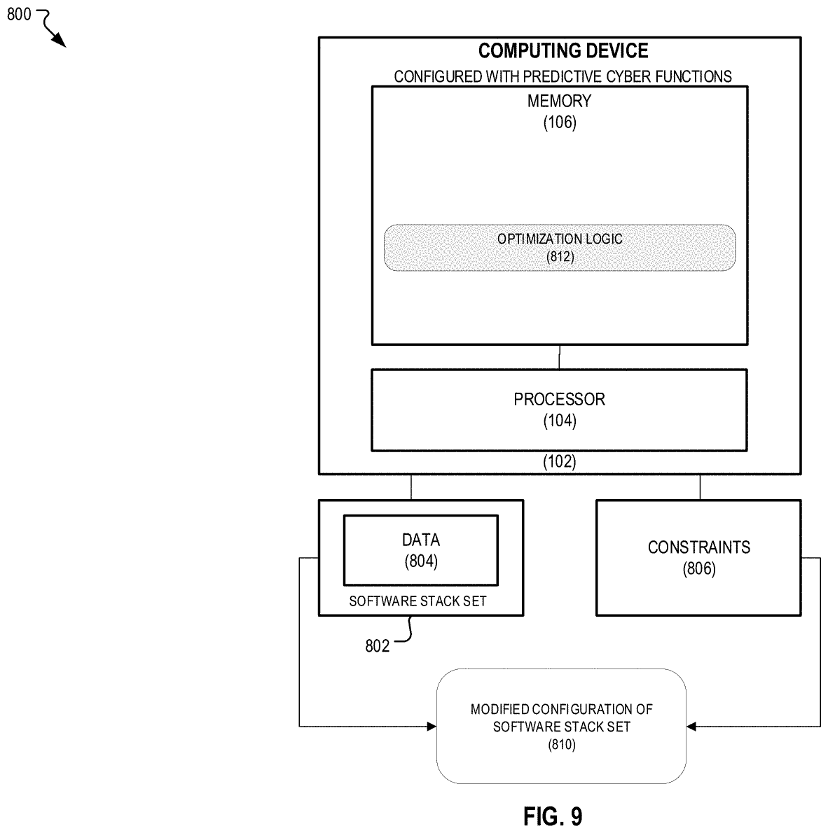

Referring to FIG. 9, in an eighth embodiment 800, the system 100 is configured to modify a configuration of a software stack to minimize threat while limiting the number of changes. Suppose the user has an existing software stack, and is now looking to change out pieces of software and solving the constraints described for embodiment 400 may lead to extensive/expensive changes. Applying optimization logic 812 encoded as instructions within the memory 106 and executable by the processor 104, a modified configuration of the software stack set 810 can be computed, as follows.

For each software component i of a software stack 802 (data 804 defining or delineating each software component i information), we introduce a constant, b, which represents the current version number of software i. We also introduce constant k, which specifies the maximum number of changes permitted. We introduce a helper variable Hi which the set of constraints sets to one if the version of software i is changed and zero otherwise. Hence, we have the following constraints (illustrated as constraints 806):

∀i:Hᵢ∈{0,1} (9.)

∀i:1−X_{i,b}_{ᵢ}=Hᵢ (10.)

ΣᵢHᵢ≤k (11.)

So, now when 6 is maximized subject to 4, 5, 7, 8, 9, 10, and 11 we can restrict, or totally limit the number of changes is limited to k.

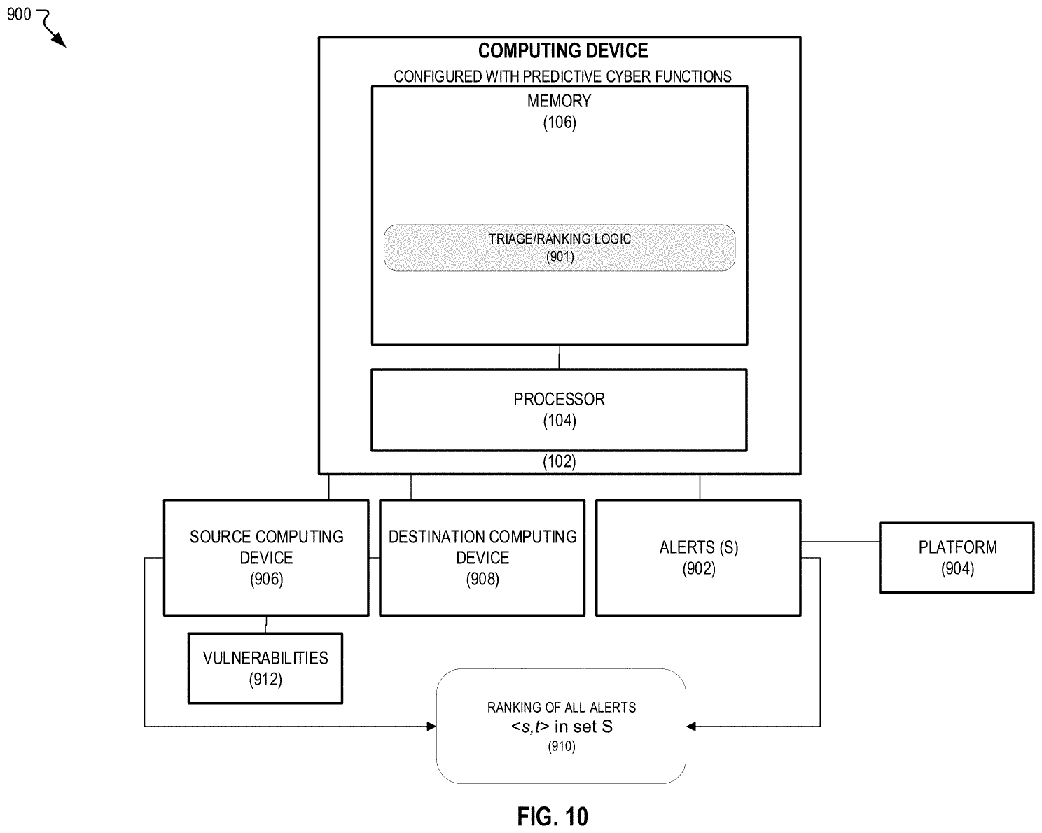

Referring to FIG. 10, in a ninth embodiment 900, the system 100 is configured for threat-based triage of system, and applies triage/ranking logic 901 encoded as instructions within the memory 106 and executable by the processor 104, as follows Given a set of alerts (S) (illustrated as alerts 902) on network traffic from a platform (illustrated as 904) such as a SIEM, orchestration tool, or intrusion detection/prevention system (IDS/IPS) implemented by some computing device of an enterprise network, such an alert can be thought to concern a source computing device s (illustrated as 906) and a destination computing device t (illustrated as 908); so, mathematically, we can say S is a set of tuples of the form <s,t>. In this case, we shall assume that the suspicious traffic originated from computing device s, and s is in the enterprise network.

So, we define a ranking 910 over all alerts <s,t> in set S (the set of alerts) based on the vulnerabilities 912 associated with computing device s and the probability of exploitation of those vulnerabilities. The vulnerabilities associated with the computing device s may be determined by a vulnerability scanning tool (see embodiment 300 of the system 100) or functionality thereof.

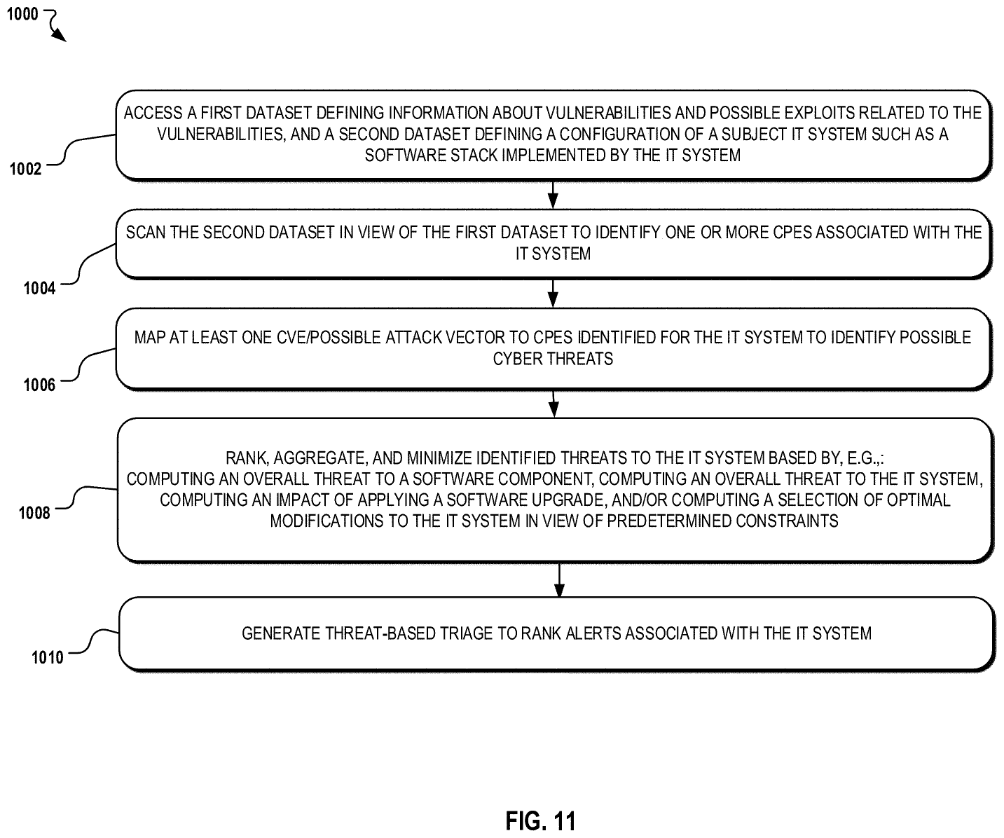

Referring now to a process flow diagram 1000 of FIG. 11, one possible implementation of various embodiments of the system 100 shall now be described. Referring to block 1002, a first dataset, or any number datasets of the data 112 may be accessed, collected, or acquired by the computing device 102 as illustrated in FIG. 1. The first dataset of the data 112 may include information from, by non-limiting examples, dark web forums, blogs, marketplaces, intelligence threat APIs, data leaks, data dumps, the general Internet or World Wide Web (126), and the like, and may be acquired using web crawling, RESTful HTTP requests, HTML parsing, or any number or combination of such methods. The data 112 may further include information originating from the NVD including CPEs, corresponding CVEs, and CVSS scores. In addition, a second dataset may be accessed by the computing device 102 from data 132 associated with the IT system 130 defining some configuration such as a software stack implemented by the IT system 130.

In one specific embodiment, using the API 119, the first dataset may be acquired from a remote database hosted by, e.g., host server 120. In this embodiment, the host server 120 gathers D2web data from any number of D2web sites or platforms and makes the data accessible to other devices. More particularly, the computing device 102 issues an API call to the host server 120 using the API 119 to establish a RESTful Hypertext Transfer Protocol Secure (HTTPS) connection. Then, the data 112 can be transmitted to the computing device 102 in an HTTP response with content provided in key-value pairs (e.g., JSON).

Once accessed, the first dataset and/or the second dataset may be preprocessed by, e.g., cleaning, formatting, sorting, or filtering the information, or modeling the information in some predetermined fashion so that, e.g., the data 112 is compatible or commonly formatted between the datasets. For example, in some embodiments, the first dataset or the second dataset may be processed by applying text translation, topic modeling, content tagging, social network analysis, or any number or combination of artificial intelligence methods such as machine learning applications. Any of such data cleaning techniques can be used to filter content of the first dataset from other content commonly discussed in the D2web such as drug-related discussions or pornography.

Referring to blocks 1004 and 1006, utilizing any number of artificial intelligence methods such as natural language processing, the processor 104 scans the data 112 to identify components of the second dataset associated with CPE identifiers corresponding to CPEs of the first dataset. More specifically, by non-limiting example, the processor 102 conducts a character or keyword search of the second dataset defining the components/inventory of the IT system 130 in view of CPE identifiers and corresponding CPEs from the first dataset. In this manner, the processor 102 identifies possible components of the IT system 130 that are affiliated with at least one CPE (and possible CVE).

In addition, the processor 102 maps at least one of the components of the IT system 130 to a CVE based on an identified CPE associated with the IT system 130. For example, an exemplary technology configuration of the IT system 130 may define a computing environment running Windows Server 2008 on an IBM computing device, and it may be discovered via intelligence from the first dataset that such an exemplary technology configuration is susceptible or vulnerable to an Attack Vector V (which may include, for example, malware, exploits, the known use of common system misconfigurations, or other attack methodology), based on e.g., historical cyber-attacks. In either case, this functionality outputs at least one CVE/attack vector that poses at least some threat to the IT system 130; and/or the functionality can be leveraged to identify a plurality or set of CVEs/attack vectors that may be ranked, aggregated, and/or minimized.

Referring to block 1008, the processor 104 may further execute functionality based on any of the embodiments of the system 100 described herein to aggregate, rank, and minimize any CVEs/attack vectors identified. Specifically, applying functionality described with the embodiments of the system 100 set forth herein, the processor 102 may process the data 112 to, for example, compute an overall threat to a software component or set of software components (stack) associated with the IT system 130, compute an overall threat to the IT system 130 based on calculated probability values defined by one or more CVEs or otherwise, compute an impact of applying a software upgrade/patch to aspects of the IT system 130, and/or compute a selection or set of optimal upgrades to the IT system 130 in view of one or more predefined constraints.

Referring to block 1010, the processor 104 may further execute functionality to generate a threat-based triage of the IT system 130 to rank alerts. This functionality may be applied according to the embodiment 900 described herein and depicted in FIG. 10.

### Exemplary Computing Device

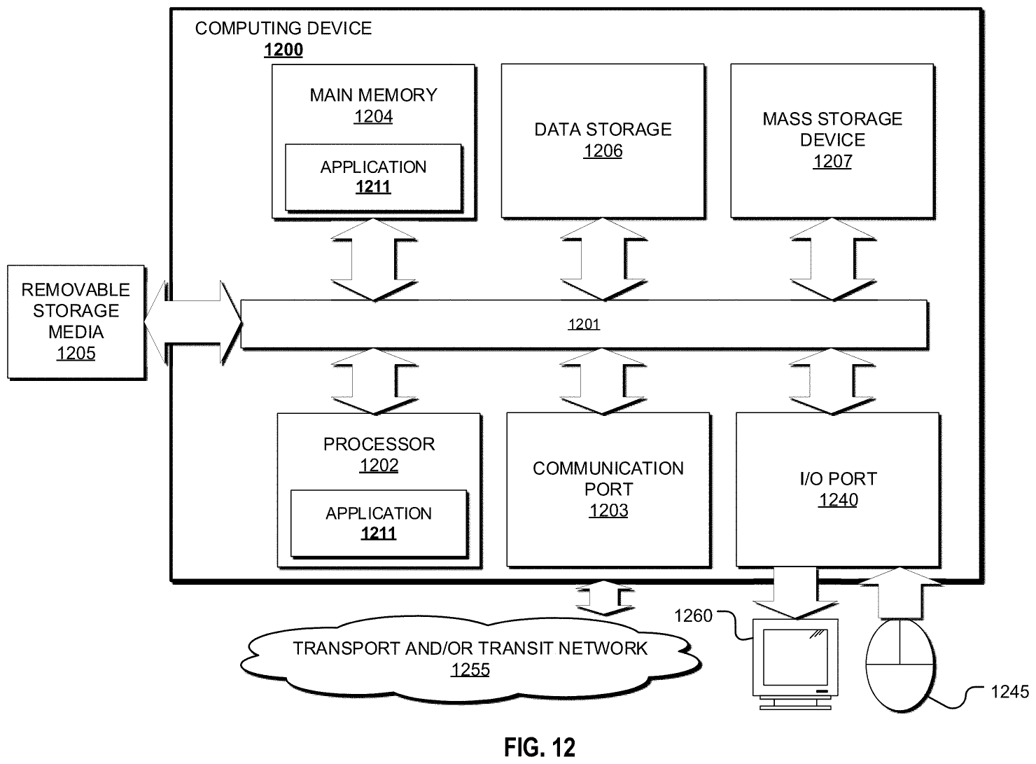

Referring to FIG. 12, a computing device 1200 is illustrated which may take the place of the computing device 102 be configured, via one or more of an application 1211 or computer-executable instructions, to execute functionality described herein. More particularly, in some embodiments, aspects of the predictive methods herein may be translated to software or machine-level code, which may be installed to and/or executed by the computing device 1200 such that the computing device 1200 is configured to execute functionality described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method for aggregating, ranking, and minimizing threats to computer systems based on external vulnerability data, comprising:
accessing data defining a configuration of a target information technology (IT) system;
(I) applying, by a processor, artificial intelligence to at least a portion of the data defining a software component of the target IT system to identify a common platform enumeration (CPE) identifier corresponding to the software component; and
(II) mapping, by the processor, the CPE identifier to a common vulnerability enumeration (CVE) identifier to identify a vulnerability for the software component of the target IT system.

2. The method of claim 1, further comprising applying, by the processor, natural language processing functions to correlate the CPE identifier with an identifier of the software component to identify the CPE identifier.

3. The method of claim 2, further comprising identifying, using natural language processing functions executed by the processor, at least one predetermined character that is common to characters of both of the identifier of the software component and the CPE identifier.

4. The method of claim 1, further comprising, by the processor, repeating step (I) to identify a plurality of CPEs associated with a software stack of the target IT system.

5. The method of claim 4, further comprising, by the processor, repeating step (II) to identify a plurality of CVEs corresponding to the plurality of CPEs associated with the software stack of the target IT system.

6. The method of claim 5, further comprising:
computing, by the processor, a probability of exploitation associated with each of the plurality of CVEs, and
computing, by the processor, a probability that the IT system will be exploited (Cx), expressed as 1—a probability that none of the vulnerabilities are going to be exploited.

7. The method of claim 5, further comprising:
computing, by the processor, a probability of exploitation associated with each of the plurality of CVEs; and
computing, by the processor, a probability that the IT system will be exploited (Cx), where Cx is expressed by taking a probability of exploitation of the vulnerability that has a greatest probability of exploitation.

8. The method of claim 1, further comprising:
computing, by the processor, a probability of exploitation associated with the IT system by computing an expected value relating to an expected number of attacks against the vulnerabilities associated with the IT system.

9. The method of claim 1, further comprising:
identifying an impact of employing a software patch to the software component, by:
computing a function that quantifies the impact and takes as inputs a threat level associated with an older software version and a threat level associated with an updated software version.

10. The method of claim 1, further comprising:
identifying an impact of employing a software patch to the software component, by:
computing a function that quantifies an impact of patching a single vulnerability of the IT system.

11. The method of claim 1, further comprising:
solving, by the processor an optimization problem using integer programming to identify the optimal set of software upgrades that may be applied to the IT system that reduces threat in view of a software upgrade constraint, k.

12. The method of claim 1, further comprising:
selecting, by the processor, an optimal set of software changes to the IT system to minimize threat by solving an optimization problem using integer programming in view of at least one incompatibility constraint.

13. The method of claim 1, further comprising:
identifying, by the processor, a change to the IT system based on a limit defining a maximum number of changes permitted.

14. The method of claim 1, further comprising, given a set of alerts, computing, by the processor, a ranking based on vulnerabilities of the IT system and probability of exploitation of the vulnerabilities to provide threat-based alert triage.

15. A device for aggregating, ranking, and minimizing threats to computer systems based on external vulnerability data, comprising:
a processor;
a network interface in operable communication with the processor, the network interface operable for communicating with a network and providing the processor with access to information including common platform enumerations (CPEs) and corresponding common vulnerability enumerations (CVEs), and
a memory storing a set of instructions executable by the processor, the set of instructions, when executed by the processor, operable to:
access data associated with an IT system, the data defining a software component implemented by the IT system, and
identify a CPE of the CPEs associated with the software component.

16. A tangible, non-transitory, computer-readable media having instructions encoded thereon, the instructions, when executed by a processor, are operable to:
access data associated with an IT system, the data defining a software component implemented by the IT system, and
identify a CPE of the CPEs associated with the software component.
